(19) United States
(12) Patent Application Publication
(10) Pub. No.: US 2013/0070170 A1
(43) Pub. Date: Mar. 21, 2013

(54) LIGHTING DEVICE, DISPLAY DEVICE AND TELEVISION DEVICE

(71) Applicant: Yuuki Namekata, Osaka-shi (JP)

(72) Inventor: Yuuki Namekata, Osaka-shi (JP)

(21) Appl. No.: 13/696,823

(22) PCT Filed: Mar. 10, 2011
(86) PCT No.: PCT/JP2011/055594

§ 371 Date: Nov. 8, 2012

(30) Foreign Application Priority Data
May 14, 2010 (JP) 2010-112416

(51) Int. Cl. F21V 7/04; H04N 5/64

(52) U.S. Cl. 348/836; 362/297; 362/235; 348/E05.133

(57) ABSTRACT

An object of the present invention is to provide a lighting device configured to suppress uneven brightness. A backlight unit 12 according to the present invention includes LEDs 17 as light sources, a chassis 14 housing the LEDs 17 and including an opening 14b through which light from the LEDs 17 exits, an optical member 15 arranged to cover the opening 14b and face the LEDs 17, and a reflection sheet 19 arranged in the chassis 14 to face the optical member 15. A surface in the chassis 14 facing the optical member 15 includes a light source arrangement area LA in which the LEDs 17 are arranged and a light source non-arrangement area LN in which no LED 17 is arranged. The light source arrangement area LA corresponds to a low light reflectance area LRA having relatively low light reflectance, and the light source non-arrangement area LN corresponds to a high light reflectance area HRA having relatively high light reflectance.

### TECHNICAL FIELD

The present invention relates to a lighting device, a display device and a television device.

### BACKGROUND ART

A liquid crystal panel for use in a liquid crystal display device such as a liquid crystal television set requires a backlight unit separately as a lighting device since the liquid crystal panel does not emit light. This backlight unit is installed on a backside (opposite side of a display surface) of the liquid crystal panel and includes a chassis having an opening on a surface on a liquid crystal panel side, a light source housed in the chassis, an optical member (diffuser sheet and the like) provided at the opening of the chassis so as to face the light source and exit light from the light source to the liquid crystal panel side efficiently, and a reflection sheet provided in the chassis so as to face the optical member and reflect light to a side of the opening of the chassis. As the light source as one of the aforementioned components of the backlight unit, LEDs are used in some cases, for example. In this case, an LED board mounting the LEDs thereon is housed in the chassis.

As an example of the backlight unit using LEDs as a light source, one described in Patent Document 1 shown below is known.
Patent Document 1: Japanese Unexamined Patent Publication No. 2006-120644

### Problem to be Solved by the Invention

In a configuration where the aforementioned liquid crystal display device including the LED board is to be thinner, for example, a distance between the optical member and the LEDs needs to be shortened. However, in such a case, light from the LEDs irradiates the optical member without sufficient diffusion, and thus an area in which the LEDs are arranged and an area in which no LED is arranged differ in contrast significantly, which may cause uneven brightness in outgoing light from the optical member. Additionally, in a configuration where the number of LEDs to be installed is reduced to reduce power consumption and manufacturing cost, an interval between the LEDs adjacent to each other increases, and thus an area in which the LEDs are arranged and an area in which no LED is arranged differ in brightness significantly in a similar manner, which may cause uneven brightness.

### DISCLOSURE OF THE PRESENT INVENTION

The present invention was made in view of the foregoing circumstances. An object of the present invention is to suppress uneven brightness.

### Means for Solving the Problem

A lighting device according to the present invention includes a light source, a chassis housing the light source and including an opening through which light from the light source exits, an optical member provided to cover the opening and face the light source, and a reflection member arranged in the chassis to face the optical member. The reflection member includes a surface facing the optical member, and the surface includes alight source arrangement area in which the light source is arranged and a light source non-arrangement area in which no light source is arranged. In addition, the light source arrangement area is a low light reflectance area having relatively low light reflectance and the light source non-arrangement area is a high light reflectance area having relatively high light reflectance.

In the lighting device configured as above, light emitted from the light source includes one emitted from the light source and exited to the optical member directly and one emitted from the light source and exited to the optical member indirectly by being reflected by the reflection member and the like arranged in the chassis to face the optical member, and hereinafter the former is referred to as direct light and the latter is referred to as indirect light. The surface in the chassis facing the optical member is defined in the light source arrangement area in which the light source is arranged, and the light source non-arrangement area in which no light source is arranged.

In this context, the present inventors have discovered that, on the surface in the chassis facing the optical member, the light source arrangement area has relatively much direct light while the light source non-arrangement area has relatively little direct light, and have arrived at inventing the following configuration based on this. That is, in the present invention, since the light source arrangement area is the low light reflectance area having relatively low light reflectance, and the light source non-arrangement area is the low light reflectance area having relatively high light reflectance, this configuration can suppress the light amount, which tends to be excessive, in the light source arrangement area having relatively much direct light while compensating the light amount, which tends to be insufficient, in the light source non-arrangement area having relatively little direct light. Since this suppresses a difference in brightness between the light source arrangement areas and the light source non-arrangement area, uneven brightness does not occur easily in outgoing light from the optical member.

In this manner, since uneven brightness does not occur easily in outgoing light, the distance between the light sources and the optical member can be reduced, which enables thinning of the lighting device, for example. Additionally, the number of light sources to be installed can be reduced, which enables reduction in power consumption and manufacturing cost of the lighting device, for example.

Embodiments of the present invention are preferably configured in the following manner.

(1) The light source may include a plurality of light sources that are arranged linearly to form a light source group, and the light source arrangement area that corresponds to the low light reflectance area may be formed in a strip shape extending along an arranging direction in which the light sources included in the light source group. In this configuration, since light from the respective light sources included in the light source group is reflected on the strip-like low light reflectance area extending along the arranging direction of the light sources, it is possible to suitably suppress an excessive increase in light amount in the light source arrangement area.

(2) The light source group may include a plurality of light source groups that are arranged at intervals in a direction intersecting with the arranging direction of the light sources The light source arrangement area that corresponds to the low light reflectance area includes a plurality of light source arrangement areas and the light source non-arrangement area that corresponds to the high light reflectance area include a plurality of light source non-arrangement areas, and each of the light source arrangement areas, the low light reflectance areas, the light source non-arrangement areas and the high light reflectance areas may be formed in a strip shape. The light source arrangement areas and the light source non-arrangement areas may be arranged alternately in the direction intersecting with the arranging direction of the light sources. In this configuration, light from the respective light sources included in the respective light source groups is reflected by the low light reflectance areas and the high light reflectance areas formed in strip shapes and arranged alternately in the direction intersecting with the arranging direction of the light sources, and thus a difference in brightness does not occur easily between the light source arrangement areas and the light source non-arrangement areas. In comparison with a configuration in which only one light source group is provided, the present configuration suppresses uneven brightness and is suitable for an increase in size of the lighting device.

(3) Each of the low light reflectance areas may have an approximately equal width dimensions. In this configuration, the amounts of light reflected by the respective low light reflectance areas can be approximately equal, which is further suitable for suppression of uneven brightness.

(4) Each of the high light reflectance areas may have an approximately equal width dimensions. In this configuration, the amounts of light reflected by the respective high light reflectance areas can be approximately equal, which is further suitable for suppression of uneven brightness.

(5) The light sources adjacent to each other in the arranging direction of the light sources may have an interval therebetween smaller than an interval between the light source groups that are adjacent to each other. In this configuration, even in a configuration where the light sources are densely arranged in the light source arrangement areas, an excessive increase in light amount can be suppressed suitably by the low light reflectance areas.

(6) The light sources included in the light source group may be arranged approximately at regular intervals. This configuration is more suitable for suppression of uneven brightness than a configuration where the light sources are unevenly distributed.

(7) The chassis may be formed in an elongated shape having a short side and a long side, and the arranging direction of the light sources included in the light source group may be aligned with the short side of the chassis. In this configuration, the length dimension of the light source arranging area is smaller than that in a configuration where the arranging direction of the light sources is aligned with the longer side direction of the chassis. Thus, the difference in contrast from the light source non-arrangement area that can occur is not recognized easily, which is suitable for prevention of uneven brightness.

(8) The lighting device may further include a light source board arranged in the chassis and having the light sources included in the light source groups thereon. In this configuration, the plurality of light sources included in the light source groups can be arranged in the chassis collectively by arranging the light source board in the chassis, which provides excellent assembling workability.

(9) The light source board may be formed in an elongated shape having a short side and a long side, and the arranging direction of the light sources included in the light source group may be aligned with a long side of the light source board. In this configuration, the light sources can be arranged on the elongated light source board efficiently.

(10) The low light reflectance area may have a surface color different from the high light reflectance area. In this configuration, the light reflectance in each area can be easily adjusted by setting the surface color arbitrarily.

(11) The high light reflectance area may be white. In this configuration, high light reflectance can be obtained, and thus the light amount in the light source non-arranging area can be compensated sufficiently.

(12) The low light reflectance area may be black. In this configuration, low light reflectance can be obtained, and thus an excessive increase in light amount in the light source arranging area can further suitably be suppressed.

(13) The reflection member may include a high light reflectance portion configuring the high light reflectance area and a low light reflectance portion configuring the low light reflectance area. In this configuration, since the high light reflectance portion and the low light reflectance portion are part of the reflection member, the number of components can be reduced further than in a configuration where the high light reflectance portion or the low light reflectance portion is a separate component from the reflection member, which is suitable for cost reduction.

(14) One of the low light reflectance portion and the high light reflectance portion may include the reflection member having a colored surface. In this configuration, the low light reflectance portion and the high light reflectance portion can be formed on the reflection member integrally at lower cost than in a configuration where both the low light reflectance portion and the high light reflectance portion are formed by coloring the surface of the reflection member.

(15) The low light reflectance portion may include the reflection member with a colored surface. In a configuration where the high light reflectance portion is formed by coloring, a material for use in coloring needs to have higher light reflectance than that of the surface of the reflection member, and thus there are few options for the material, and the material tends to be costly. In this respect, in the present invention, since the low light reflectance portion is formed by coloring, there are many options for the material for use in coloring, and the material can be provided at low cost.

(16) The reflection member may include a high light reflectance portion constituting the high light reflectance area, and a low light reflectance portion configuring the low light reflectance area may be arranged to overlap with the reflection member. In this configuration, by adding the low light reflectance member, an existing member can be used as it is as the reflection member. Accordingly, cost for the reflection member can be reduced to be low.

(17) The low light reflectance portion may be arranged to overlap with the reflection member on a side of the optical member. In this configuration, although an opening that exposes the low light reflectance member need to be formed in the reflection member in a configuration where the low light reflectance member is arranged on the reflection member on an opposite side of the side of the optical member, this is not needed in the present invention, and thus cost for the reflection member can be reduced to be low.

(18) The lighting device may further include a light source board having the light sources thereon, and the low light reflectance portion may be the light source board. In this configuration, since the light source board having the light sources is the low light reflectance portion, the number of components can be reduced further than in a configuration where the low light reflectance portion is a separate component from the light source board, which is suitable for cost reduction.

(19) The surface in the chassis facing the optical member may have two-level light reflectance. In this configuration, the light reflectance of the surface in the chassis facing the optical member is set easily, which is excellent in manufacture of the lighting device.

(20) The surface in the chassis facing the optical member may have light reflectance decreased continuously and gradually from the light source arranging area to the light source non-arranging area. In this manner, by setting the light reflectance on the surface in the chassis opposed to the optical member so as to form gradation from the light source arranging area to the light source non-arranging area, and more specifically, by decreasing the light reflectance continuously and gradually, brightness distribution of outgoing light can be moderate, which is further suitable for suppression of uneven brightness.

(21) The reflection member may have a dot pattern on its surface, and the dot pattern may be made of a material having light reflectance lower than the surface of the reflection member. In this configuration, the degree of reflection can be controlled appropriately in accordance with the conditions (number, area, and the like) of the dot pattern, and thus brightness distribution of outgoing light can be smoother.

(22) The light source may be an LED. In this configuration, high brightness and low power consumption can be achieved.

Next, to solve the above problem, a display device according to the present invention includes the aforementioned lighting device and a display panel displaying with use of light from the lighting device.

According to the display device, since the lighting device, which supplies the display panel with light, can suppress uneven brightness, it is possible to achieve display excellent in display quality.

A liquid crystal panel can be illustrated as the display panel. Such a display device can be applied as a liquid crystal display device to various applications such as a television set and a display for a personal computer and is especially suitable for a large-sized screen.

### Advantageous Effect of the Invention

According to the present invention, uneven brightness can be suppressed.

### BRIEF DESCRIPTION OF THE DRAWINGS

FIG. 1 is an exploded perspective view illustrating a schematic configuration of a television device according to a first embodiment of the present invention;

FIG. 2 is an exploded perspective view illustrating a schematic configuration of a liquid crystal display device included in the television device;

FIG. 3 is a plan view illustrating an arrangement configuration of LED boards and a reflection sheet in a chassis included in the liquid crystal display device;

FIG. 4 is a cross-sectional view illustrating a cross-sectional configuration along a shorter side direction of the liquid crystal display device;

FIG. 5 is a cross-sectional view illustrating a cross-sectional configuration along a longer side direction of the liquid crystal display device;

FIG. 6 is a detailed cross-sectional view illustrating a cross-sectional configuration along the longer side direction of the liquid crystal display device;

FIG. 7 is a graph illustrating changes in light reflectance along a longer side direction (X axial direction) of a bottom portion of the reflection sheet included in the liquid crystal display device;

FIG. 8 is a plan view illustrating an arrangement configuration of LED boards and a reflection sheet in the chassis according to a first modification example of the first embodiment;

FIG. 9 is a plan view illustrating an arrangement configuration of an LED board and a reflection sheet in the chassis according to a second modification example of the first embodiment;

FIG. 10 is an enlarged plan view of a reflection sheet according to a second embodiment of the present invention;

FIG. 11 is a graph illustrating changes in light reflectance along a longer side direction (X axial direction) of a bottom portion of the reflection sheet;

FIG. 12 is an enlarged plan view of a reflection sheet according to a third embodiment of the present invention;

FIG. 13 is a graph illustrating changes in light reflectance along a longer side direction (X axial direction) of a bottom portion of the reflection sheet;

FIG. 14 is a plan view illustrating an arrangement configuration of LED boards and a reflection sheet in the chassis according to a fourth embodiment of the present invention;

FIG. 15 is a detailed cross-sectional view illustrating a cross-sectional configuration along a longer side direction of the liquid crystal display device;

FIG. 16 is a plan view illustrating an arrangement configuration of LED boards and a reflection sheet in the chassis according to a fifth embodiment of the present invention; and

FIG. 17 is a detailed cross-sectional view illustrating a cross-sectional configuration along a longer side direction of the liquid crystal display device.

### BEST MODE FOR CARRYING OUT THE INVENTION

### First Embodiment

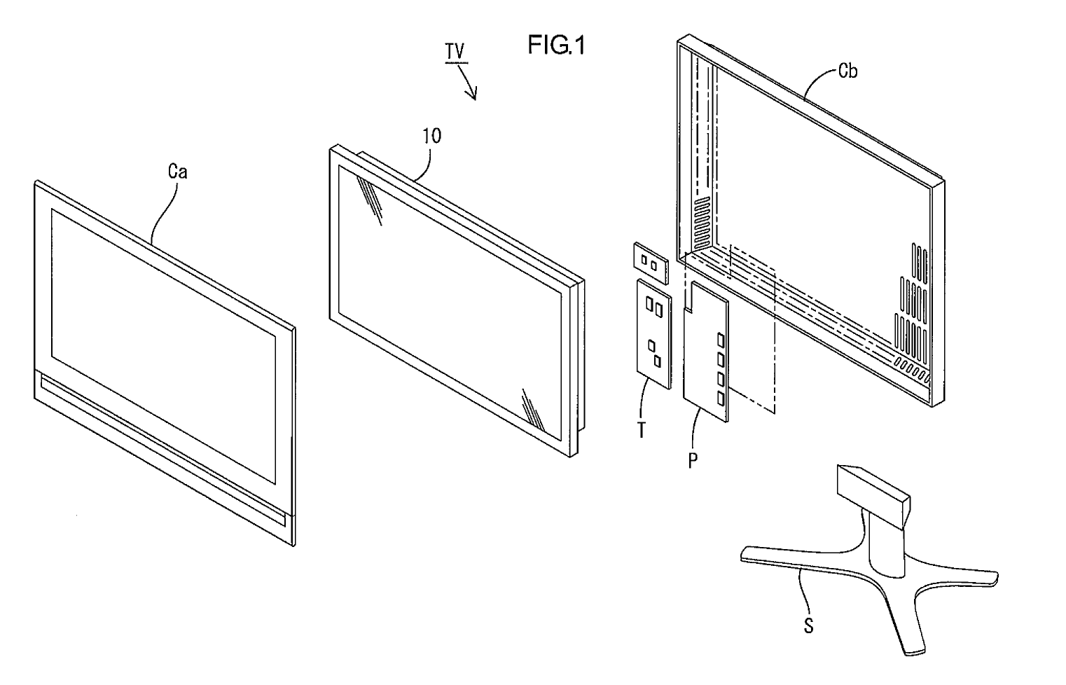

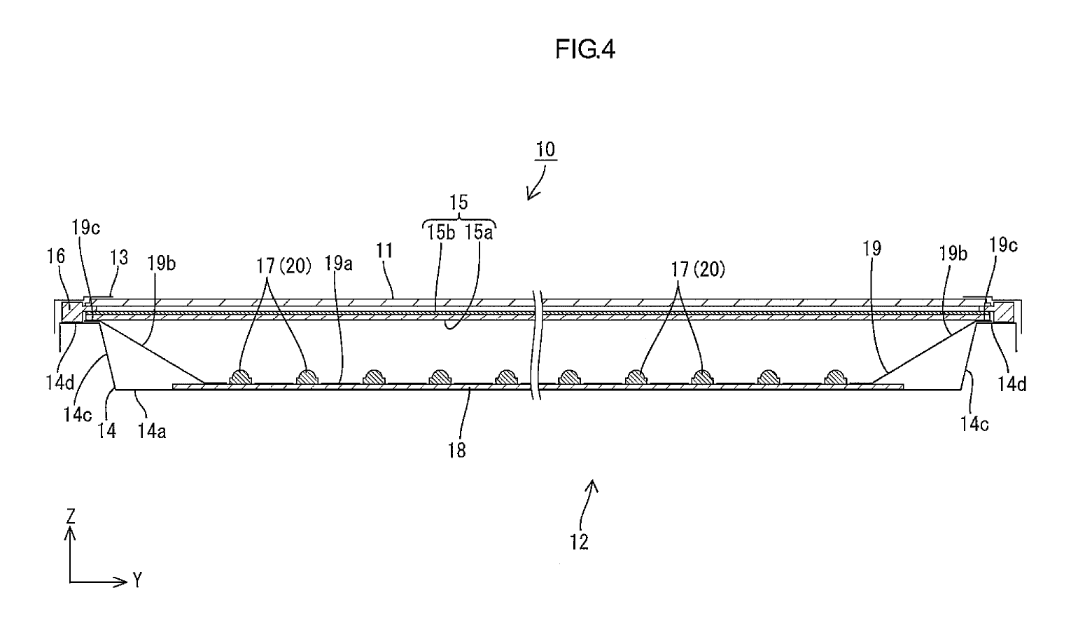

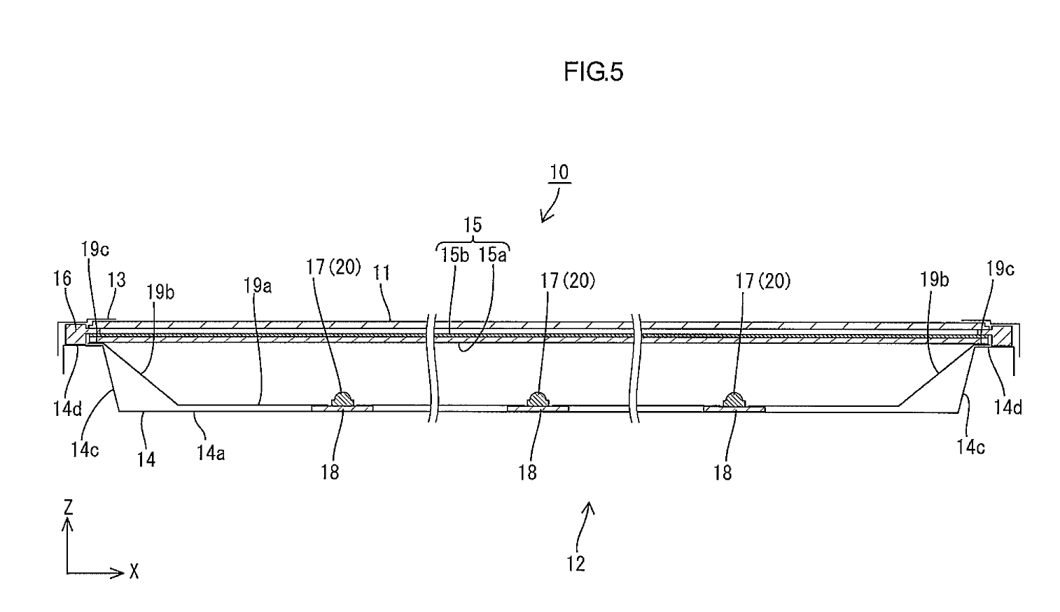

A first embodiment of the present invention will be described with reference to FIGS. 1 to 7. In the present embodiment, a liquid crystal display device 10 will be illustrated. It is to be noted that some of the drawings have X, Y and Z axes shown therein such that the respective axial directions are directed in common in the respective drawings. Also, the upper side in each of FIGS. 4 and 5 corresponds to a front side and the lower side corresponds to a back side.

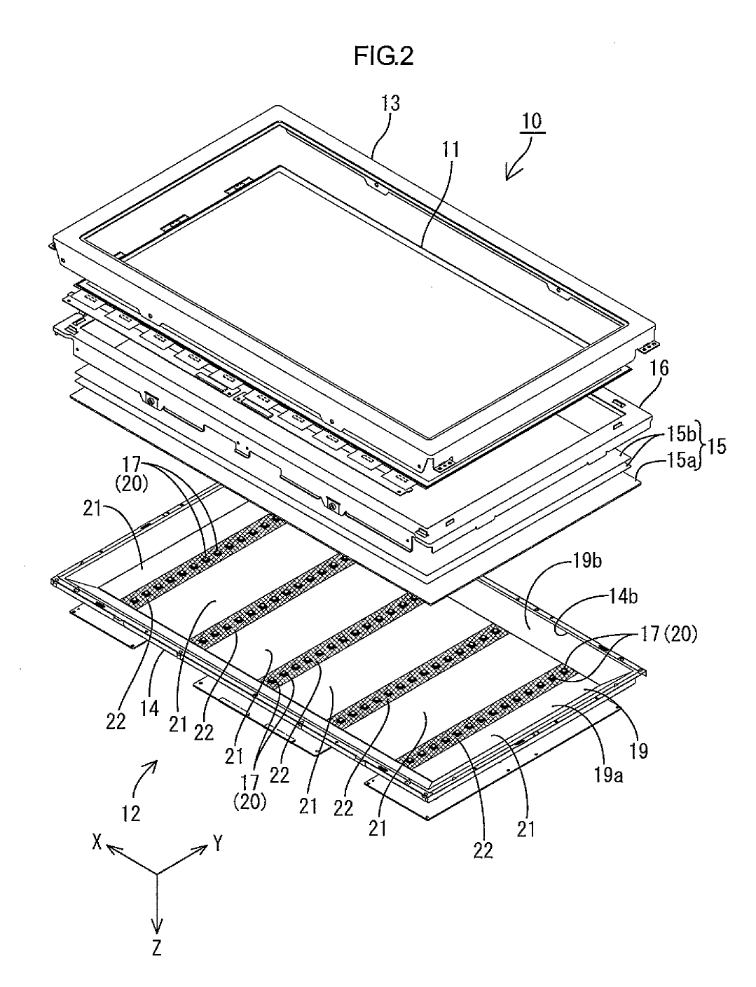

A television device TV according to the present embodiment includes the liquid crystal display device 10, front and back cabinets Ca and Cb housing the liquid crystal display device 10 so as to sandwich the liquid crystal display device 10 inbetween, a power source P, a tuner T and a stand S, as illustrated in FIG. 1. The liquid crystal display device (display device) 10 is formed in a horizontally long (elongated) square shape (long rectangular shape) as a whole and is housed in a vertically-placed state. As illustrated in FIG. 2, this liquid crystal display device 10 includes a liquid crystal panel 11 as a display panel and a backlight unit (lighting device) 12 as an external light source such that these may be held integrally by a frame-like bezel 13 or the like.

Next, the liquid crystal panel 11 and the backlight unit 12 constituting the liquid crystal display device 10 will be described in order. First, the liquid crystal panel (display panel) 11 is formed in a horizontally long square shape in a planar view and has a configuration in which glass substrates as a pair are attached to each other in a state of leaving a predetermined gap and in which liquid crystal is filled between the glass substrates. One glass substrate is provided with switching components (such as TFTs) connected to source lines and gate lines perpendicular to each other, pixel electrodes connected to the switching components, an alignment film, and the like while the other glass substrate is provided with color filters having respective color sections such as R (red), G (green) and B (blue) arranged in a predetermined array, counter electrodes, an alignment film, and the like. Polarizing plates are disposed on external sides of the substrates.

Next, the backlight unit 12 will be described in details. As illustrated in FIG. 2, the backlight unit 12 includes a chassis 14 formed approximately in a box shape having an opening 14b on a light emitting side (side of the liquid crystal panel 11), an optical member 15 group arranged to cover the opening 14b of the chassis 14 (a diffuser plate (light diffusing member) 15a and a plurality of optical sheets 15b arranged between the diffuser plate 15a and the liquid crystal panel 11), and a frame 16 arranged along an outer edge portion of the chassis 14 to sandwich and hold an outer edge portion of the optical member 15 group with the chassis 14. The backlight unit 12 is further provided in the chassis 14 with LEDs 17 (Light Emitting Diode) as light sources, LED boards 18 on which the LEDs 17 are mounted, and a reflection sheet 19 reflecting light in the chassis 14 to a side of the optical member 15. In this manner, the backlight unit 12 according to the present embodiment is in a so-to-speak direct type. In the backlight unit 12, a side closer to the optical member 15 than the LEDs 17 is a light emitting side. Hereinafter, the respective components of the backlight unit 12 will be described in details.

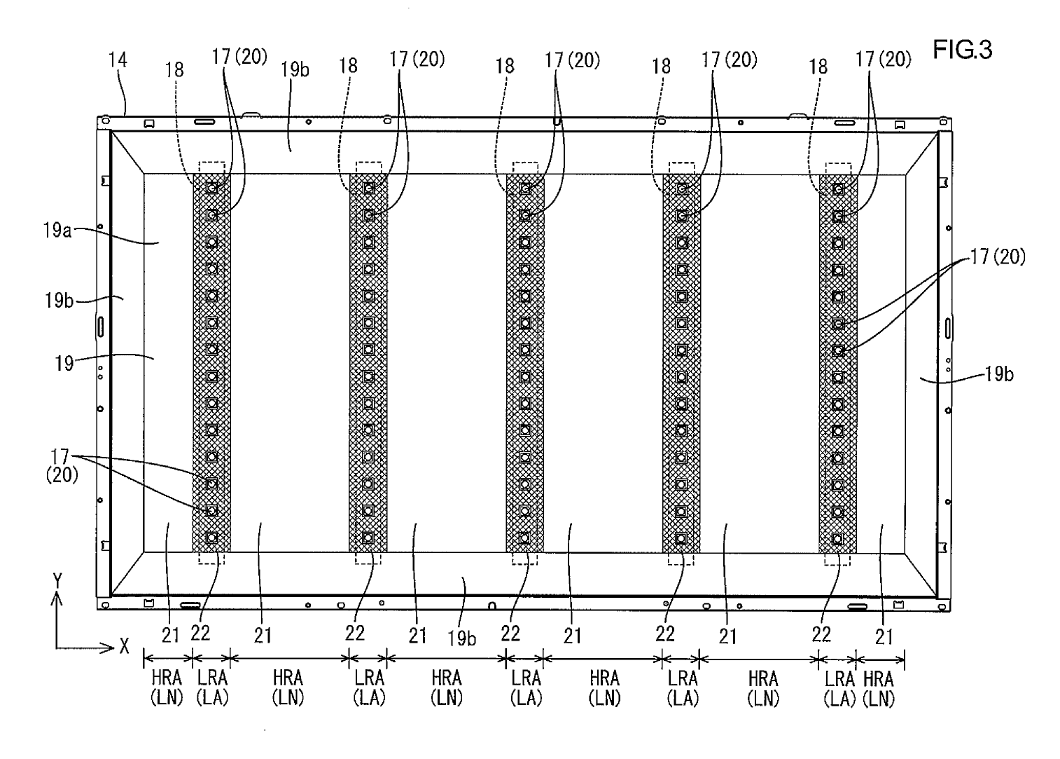

The chassis 14 is made of a metal, includes a bottom plate 14a formed in a horizontally long square shape (rectangular shape) in a similar manner to that of the liquid crystal panel 11, side plates 14c respectively rising to the front side (light emitting side) from respective outer ends of respective sides (a pair of longer sides and a pair of shorter sides) of the bottom plate 14a, and receiving plates 14d extending outward from rising ends of the respective side plates 14c. The chassis 14 is formed as a whole in a shallow and approximately-box-like shape (approximately in a shallow-dish shape) opened toward the front side, as illustrated in FIGS. 3 to 5. As for the chassis 14, a longer side direction thereof is aligned with an X axial direction (horizontal direction) while a shorter side direction thereof is aligned with a Y axial direction (vertical direction). On the respective receiving plates 14d of the chassis 14 can be put the frame 16 and the after-mentioned optical member 15 from the front side. The frame 16 is screwed shut on the respective receiving plates 14d.

The optical member 15 is formed in a horizontally long square shape in a planar view in a similar manner to those of the liquid crystal panel 11 and the chassis 14 as illustrated in FIG. 2. An outer edge portion of the optical member 15 is provided on the receiving plates 14d to cover the opening 14b of the chassis 14 and to be arranged to lie between the liquid crystal panel 11 and the LEDs 17 as illustrated in FIGS. 4 and 5. The optical member 15 includes the diffuser plate 15a arranged on the back side (a side of the LEDs 17, an opposite side of the light outgoing side) and the optical sheets 15b arranged on the front side (a side of the liquid crystal panel 11, the light outgoing side). The diffuser plate 15a has a number of diffusing particles dispersed in an approximately-transparent resin-made base substrate having a predetermined thickness and functions to diffuse transmitted light. Each of the optical sheets 15b is in a sheet form having a smaller plate thickness than that of the diffuser plate 15a, and the two optical sheets 15b are laminated. Specific examples of the optical sheet 15b are a diffuser sheet, a lens sheet, a reflection type polarizing sheet, and the like. One out of these can be selected and used arbitrarily.

The frame 16 is in a frame shape along outer circumferential portions of the liquid crystal panel 11 and the optical member 15 as illustrated in FIG. 2. The outer edge portion of the optical member 15 can be sandwiched between this frame 16 and the respective receiving plates 14d (FIGS. 4 and 5). Also, this frame 16 can receive an outer edge portion of the liquid crystal panel 11 from the back side and can sandwich the outer edge portion of the liquid crystal panel 11 with the bezel 13 arranged on the front side (FIGS. 4 and 5).

Next, the LEDs 17 and the LED boards 18 on which the LEDs 17 are mounted will be described. The LEDs 17 are configured such that LED chips are sealed by a resin material on a board portion fixed on each LED board 18 as illustrated in FIGS. 4 and 5. As each LED chip mounted on the board portion, one whose dominant emission wavelength is one kind and which specifically emits blue light in one color is used. On the other hand, a phosphor is dispersed and mixed in the resin material that seals each LED chip. The phosphor converts blue light emitted from the LED chip into white light. This enables the LED 17 to emit white light. The LED 17 is a so-called top type LED in which a surface (surface facing the optical member 15) facing a surface on which the LED board 18 is mounted is a light-emitting surface, and has an optical axis thereof aligned with a Z axial direction or a direction perpendicular to the display surface of the liquid crystal panel 11 (plate surface of the optical member 15).

The LED board 18 has a vertically long base member in a planar view and extends along the bottom plate 14a and is housed in the chassis 14 in a state in which a length direction (longer side direction) thereof is aligned with the X axial direction or the shorter side direction of the chassis 14 and in which a width direction (shorter side direction) thereof is aligned with the Y axial direction or the longer side direction of the chassis 14 as illustrated in FIG. 3. The LED board 18 has a length dimension thereof slightly longer than the shorter side dimension of the bottom plate 14a of the chassis 14 and lies across the entire area of the bottom plate 14a along the shorter side direction of the bottom plate 14a. On a surface facing the front side (surface facing the side of the optical member 15) out of the plate surfaces of the base member of this LED board 18, the aforementioned LEDs 17 are surface-mounted. The plurality of LEDs 17 is linearly arranged along the length direction of the LED board 18 (Y axial direction, shorter side direction of the chassis 14) and is connected in series by a wiring pattern formed in the LED board 18. The plurality of LEDs 17 linearly arranged on the LED board 18 constitutes one LED group 20. Intervals between the respective LEDs 17 constituting the LED group 20, that is, arrangement pitches of the LEDs 17 in the Y axial direction, are approximately equal, and thus, the respective LEDs 17 are arranged at regular intervals. The number of the LEDs 17 included in the LED group 20 is specifically fourteen.

The plurality of LED boards 18 each configured as above (LED group 20) are arranged intermittently in the X axial direction in the chassis 14, that is, in a direction perpendicular to the arranging direction (Y axial direction) of the LEDs 17 constituting each LED group 20, such that each LED board 18 may be in a posture in which the length direction is aligned with the X axial direction and in which the width direction is aligned with the Y axial direction. Specifically, as for the LED boards 18, one is arranged at a center position in the longer side direction of the chassis 14, each one is arranged at each position close to each of both ends, and each one is arranged at each middle position between one at the center position and each one at each position close to each of both ends. Five LED boards 18 are arranged in total. Intervals between the LED boards 18 adjacent to each other in the X axial direction are approximately equal to one another. The interval between the LED boards 18 adjacent to each other is longer than the width dimension of each LED board 18 and is longer than the interval between the LEDs 17 adjacent to each other in the Y axial direction. Since the LED boards 18 are arranged as above, the LEDs 17 mounted thereon are arranged in a matrix form in the X axial direction and the Y axial direction, and the arrangement pitch in the X axial direction is longer than the arrangement pitch in the Y axial direction.

In this manner, since the plurality of LED boards 18 are arranged in the X axial direction at intervals, the surface facing the optical member 15 in the chassis 14 is defined in light source arranging areas LA, in which the LEDs 17 and the LED boards 18 are arranged in the X axial direction, and light source non-arranging areas LN, in which no LEDs 17 or LED boards 18 are arranged. The light source arranging areas LA and the light source non-arranging areas LN are arranged alternately in the X axial direction. Specifically, four light source non-arranging areas LN lie between five light source arranging areas LA intermittently arranged in the X axial direction, and two light source non-arranging areas LN are also arranged so as to be adjacent to the light source arranging areas LA on both ends closer to the end sides. Each of the light source arranging areas LA and the light source non-arranging areas LN is in a vertically long strip shape, has a width direction (shorter side direction) thereof aligned with the X axial direction, has a length direction (longer side direction) thereof aligned with the Y axial direction, and lies across the entire area of the bottom plate 14a (bottom portion 19a) of the chassis 14 (reflection sheet 19) along the shorter side direction of the bottom plate 14a. A width dimension of each light source arranging area LA is shorter than a width dimension of each light source non-arranging area LN and is specifically ½ or less of the width dimension of each light source non-arranging area LN such as approximately ⅓. Since the width dimensions of the respective LED boards 18 are approximately equal to one another, the width dimensions of the respective light source arranging areas LA corresponding to these are approximately equal to one another. Also, among the light source non-arranging areas LN, one lying between the respective light source arranging areas LA is relatively wide while one arranged at each end position in the X axial direction is relatively narrow. The four relatively wide light source non-arranging areas LN have approximately equal widths to one another, and the two relatively narrow light source non-arranging areas LN have approximately equal widths to each other. In the present embodiment, the width dimension of each light source arranging area LA is slightly longer than the width dimension of each LED board 18.

The reflection sheet 19 is made of a synthetic resin and has a white front surface excellent in light reflectance. As illustrated in FIGS. 3 to 5, since the reflection sheet 19 is so large as to be laid down approximately over the entire area of the inner surface of the chassis 14, the reflection sheet 19 can cover all the LED boards 18 arranged in the chassis 14 from the front side (the side of the optical member 15, the light outgoing side) collectively. In other words, the reflection sheet 19 constitutes a surface in the chassis 14 opposed to the optical member 15. This reflection sheet 19 is adapted to enable reflection of light in the chassis 14 toward the side of the optical member 15. The reflection sheet 19 includes the bottom portion 19a extending along the bottom plate 14a of the chassis 14 and being so large as to cover a large part of the bottom plate 14a, four rising portions 19b rising toward the front side from respective outer ends of the bottom portion 19a and formed in an inclined shape to the bottom portion 19a, and extending portions 19c extending outward from outer ends of the respective erecting portions 19b and being provided on the receiving plates 14d of the chassis 14. The bottom portion 19a of this reflection sheet 19 is arranged to overlap with the front side surfaces of the respective LED boards 18, that is, mounting surfaces of the LEDs 17, on the front side. Also, the bottom portion 19a of the reflection sheet 19 is provided at positions overlapping with the respective LEDs 17 in a planar view with light source inserting holes 19d opened to have the respective LEDs 17 inserted therein individually. The plurality of light source inserting holes 19d is arranged in a matrix form in the X axial direction and the Y axial direction to correspond to arrangement of the respective LEDs 17 and is arranged approximately at the centers in the width direction in the respective light source arranging areas LA.

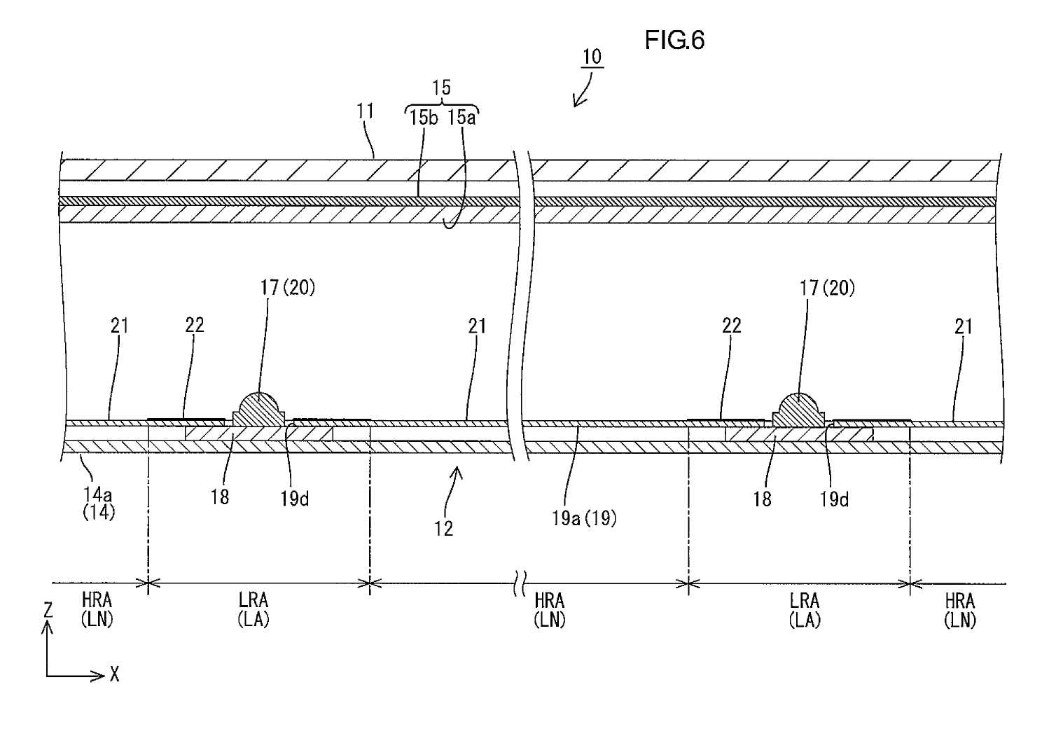

As described above, the LEDs 17 on the surface of the bottom portion 19a (bottom plate 14a) of the reflection sheet 19 (chassis 14) according to the present embodiment are unevenly distributed as illustrated in FIG. 3. That is, the LEDs 17 are arranged only in the strip-shaped respective light source arranging areas LA arranged intermittently in the X axial direction, and are not arranged in the strip-shaped light source non-arranging areas LN arranged adjacent to the respective light source arranging areas LA in the X axial direction. Accordingly, when the respective LEDs 17 are illuminated, the amount of direct light irradiating directly the optical member 15 from the respective LEDs 17 and emitted toward the liquid crystal panel 11 tends to be relatively large in the light source arranging areas LA while the amount of the aforementioned direct light tends to be relatively small in the light source non-arranging areas LN, which may cause generation of an uneven in-plane distribution of emitted light, or so-to-speak uneven brightness. Under such circumstances, in the present embodiment, in the reflection sheet 19 constituting the surface in the chassis 14 opposed to the optical member 15, each light source arranging area LA is regarded as a high light reflectance area HRA having relatively high light reflectance while each light source non-arranging area LN is regarded as a low light reflectance area LRA having relatively low light reflectance, as illustrated in FIGS. 3 and 6. Hereinafter, the high light reflectance area HRA and the low light reflectance area LRA will be described in details. Since the high light reflectance area HRA and the low light reflectance area LRA are similar to the light source arranging area LA and the light source non-arranging area LN, respectively, in terms of the shape, size (width dimension and length dimension), position on the reflection sheet 19, and the like, redundant description is omitted arbitrarily. Also, in FIGS. 2 and 3, on the bottom portion 19a of the reflection sheet 19, the light source arranging areas LA, that is the low light reflectance areas LRA (low light reflectance portions 22) are hatched.

The bottom portion 19a of the reflection sheet 19 has the surface colors different between the high light reflectance area HRA and the low light reflectance area LRA. While the color of the high light reflectance area HRA corresponds to an original color of the surface of the reflection sheet 19, the low light reflectance area LRA has a different color from that of the high light reflectance area HRA by partially coloring the bottom portion 19a of the reflection sheet 19. Specifically, on the bottom portion 19a of the reflection sheet 19, the high light reflectance area HRA is white while the low light reflectance area LRA is black. On the bottom portion 19a, a part to which black paint is applied in a strip shape wider than the LED board 18 is the low light reflectance area LRA while apart which remains white without application of black paint is the high light reflectance area HRA. Thus, the bottom portion 19a of the reflection sheet is provided with high light reflectance portions 21 constituting the high light reflectance areas HRA and the low light reflectance portions 22 constituting the low light reflectance areas LRA.

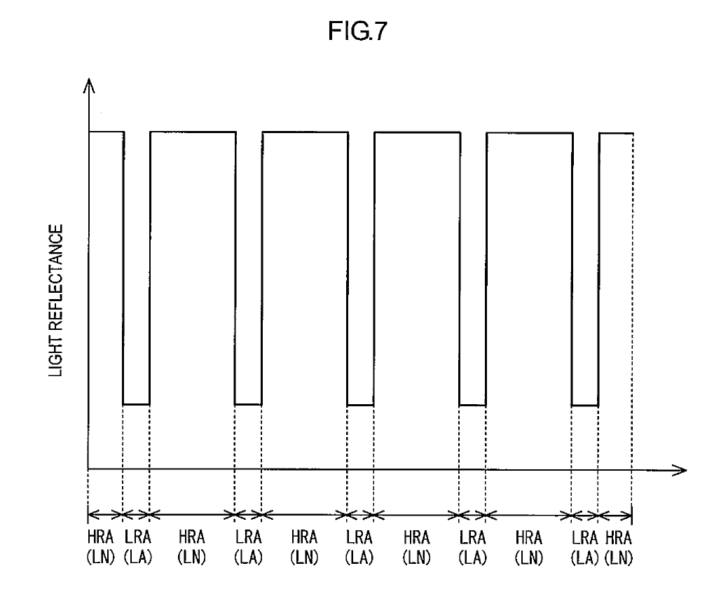

The high light reflectance portion 21 has a white surface, has the light reflection amount larger than the light absorption amount, and reflects 90% or more of light, for example. The low light reflectance portion 22 has a black surface, has the light absorption amount larger than the light reflection amount, and absorbs 90% or more of light, for example. In this manner, the light reflectance of the bottom portion 19a of the reflection sheet 19 is in two levels in the high light reflectance area HRA (high light reflectance portion 21) and low light reflectance area LRA (low light reflectance portion 22) as illustrated in FIG. 7. Also, the high light reflectance portions 21 and the low light reflectance portions 22 are arranged alternately in the X axial direction. Each of the high light reflectance portions 21 and the low light reflectance portions 22 is in a vertically long strip shape, has a width direction (shorter side direction) thereof aligned with the X axial direction, has a length direction (longer side direction) thereof aligned with the Y axial direction, and lies across the entire area of the bottom portion 19a of the reflection sheet 19 along the shorter side direction of the bottom portion 19a. A width dimension of the high light reflectance portion 21 is shorter than a width dimension of the low light reflectance portion 22 and is specifically ½ or less of the width dimension of the low light reflectance portion 22 such as approximately ⅓.

The present embodiment is configured as above, and effects thereof will then be described. When the respective LEDs 17 of the backlight unit 12 are lit for the purpose of using the liquid crystal display device 10, light emitted from the respective LEDs 17 enters the optical member 15 directly or enters it indirectly after being reflected on the reflection sheet 19 and the like, transmits the optical member 15, and thereafter exits toward the liquid crystal panel 11, as illustrated in FIGS. 4 and 5. Hereinafter, light incoming directly to the optical member 15 is referred to as direct light while light incoming indirectly is referred to as indirect light. The indirect light includes light that is reflected on the surface of the optical member 15 or the liquid crystal panel 11, is once returned to the chassis 14, is reflected by the reflection sheet 19, and enters the optical member 15 again.

In this context, on the bottom portion 19a of the reflection sheet 19 constituting the surface in the chassis 14 opposed to the optical member 15, the LED groups 20 are unevenly arranged on the surface, and the bottom portion 19a is defined in the light source arranging areas LA, in which the LED groups 20 are arranged, and the light source non-arranging areas LN, in which no LED groups 20 are arranged, as illustrated in FIG. 3. Thus, when the respective LEDs 17 emit light, apart of the optical member 15 overlapping with the light source arranging area LA in a planar view tends to receive relatively much direct light, which is emitted directly from the respective LEDs 17 to the optical member 15, but a part of the optical member 15 overlapping with the light source non-arranging area LN in a planar view tends to receive relatively little direct light. On the other hand, indirect light, which is reflected by the reflection sheet 19 and thereafter indirectly irradiates the optical member 15, has a similar tendency to that of the aforementioned direct light in a configuration where the light reflectance on the reflection sheet 19 is even. However, in the present embodiment, on the bottom portion 19a of the reflection sheet 19, since the light source arranging area LA, which is in proximity to the LED group 20 and in which the amount of light emitted from the respective LEDs 17 is relatively large, is the low light reflectance area LRA, which has relatively low light reflectance, most light from the respective LEDs 17 is absorbed by the low light reflectance portion 22 constituting the low light reflectance area LRA, and only a little light is reflected and becomes indirect light. Conversely, on the bottom portion 19a, since the light source non-arranging area LN, which is away from the LED group 20 and in which the amount of light emitted from the respective LEDs 17 is relatively small, is the high light reflectance area HRA, which has relatively high light reflectance, most light from the respective LEDs 17 is efficiently reflected by the high light reflectance portion 21 constituting the high light reflectance area HRA and becomes indirect light. Accordingly, on the optical member 15, while apart overlapping with the light source arranging area LA in a planar view receives relatively much direct light but receives relatively little indirect light due to the low light reflectance area LRA, a part overlapping with the light source non-arranging area LN in a planar view receives relatively little direct light but receives relatively much indirect light due to the high light reflectance area HRA, and a difference in amount of emitted light between these parts is alleviated and becomes subtle. Consequently, even in a configuration where a distribution of the respective LED groups 20 on the surface of the optical member 15 is uneven, distributions in amount of incoming light and amount of outgoing light on the surface of the optical member 15 become approximately even, which suppresses generation of uneven brightness.

As described above, since uneven brightness of outgoing light in the backlight unit 12 can be suppressed in the present embodiment, the following effects can also be obtained. For example, in general, in a configuration where the distance in the Z axial direction between the LEDs 17 and the optical member 15 is reduced, uneven brightness is easily generated since light from the LEDs 17 enters the optical member 15 without diffusing. However, by using the reflection sheet 19 according to the present embodiment, uneven brightness can be suppressed, and thus the distance in the Z axial direction between the LEDs 17 and the optical member 15 can be reduced further, which enables thinning of the backlight unit 12 and the liquid crystal display device 10. Additionally, in general, in a configuration where the number of LEDs 17 to be installed is reduced, a difference in contrast easily occurs between the light source arranging areas LA and the light source non-arranging areas LN since the light source arranging areas LA shrink while the light source non-arranging areas LN expand. However, by using the reflection sheet 19 according to the present embodiment, uneven brightness can be suppressed, and thus the number of LEDs 17 to be installed can be reduced, which enables reduction in power consumption and manufacturing cost of the backlight unit 12 and the liquid crystal display device 10.

As described above, the backlight unit 12 according to the present embodiment includes the LEDs 17 as light sources, the chassis 14 housing the LEDs 17 and including the opening 14b for light of the LEDs 17 to be emitted, the optical member 15 arranged to cover the opening 14b and face the LEDs 17, and the reflection sheet 19 arranged in the chassis 14 to face the optical member 15. The surface in the chassis 14 facing the optical member 15 is defined in the light source arranging areas LA, in which the LEDs 17 are arranged, and the light source non-arranging areas LN, in which no LEDs 17 are arranged. Each light source arranging area LA is the low light reflectance area LRA, which has relatively low light reflectance, while each light source non-arranging area LN is the high light reflectance area HRA, which has relatively high light reflectance.

In the backlight unit 12 configured as above, light emitted from the LEDs 17 includes one directly irradiating the optical member 15 and exiting therefrom and one indirectly irradiating the optical member 15 by being reflected by the reflection sheet 19 arranged in the chassis 14 facing the optical member 15 and exiting therefrom. Hereinafter, the former is referred to as direct light while the latter is referred to as indirect light. The surface in the chassis 14 facing the optical member 15 is defined in the light source arranging areas LA, in which the LEDs 17 are arranged, and the light source non-arranging areas LN, in which no LEDs 17 are arranged.

In this context, the present inventors have discovered that, on the surface in the chassis 14 facing the optical member 15, the light source arranging areas LA have relatively much direct light while the light source non-arranging areas LN have relatively little direct light and have reached the following configuration based on this. That is, in the present embodiment, since each light source arranging area LA is the low light reflectance area LRA, which has relatively low light reflectance, while each light source non-arranging area LN is the low light reflectance area LRA, which has relatively high light reflectance, the light amount, which tends to be excessive, can be suppressed in the light source arranging areas LA having relatively much direct light while the light amount, which tends to be insufficient, can be compensated in the light source non-arranging areas LN having relatively little direct light. Since this suppresses occurrence of a difference in contrast between the light source arranging areas LA and the light source non-arranging areas LN, uneven brightness does not occur easily in outgoing light from the optical member 15.

In this manner, since uneven brightness does not occur easily in outgoing light, the distance between the LEDs 17 and the optical member 15 can be reduced, which enables thinning of the backlight unit 12, for example. Additionally, the number of LEDs 17 to be installed can be reduced, which enables reduction in power consumption and manufacturing cost of the backlight unit 12, for example.

The plurality of LEDs 17 is linearly arranged to constitute the LED group 20, and each of the light source arranging areas LA, that is the low light reflectance areas LRA is in a strip shape extending along an arranging direction of the LEDs 17 constituting the LED group 20. In this configuration, since light from the respective LEDs 17 constituting the LED group 20 is reflected on the strip-like low light reflectance areas LRA extending along the arranging direction of the LEDs 17, it is possible to suitably suppress an excessive increase in light amount in the light source arranging areas LA.

The plurality of LED groups 20 is arranged at intervals in a direction intersecting with the arranging direction of the LEDs 17, and the light source arranging areas LA, that is the low light reflectance areas LRA, and the light source non-arranging areas LN, that is the high light reflectance areas HRA, are in strip shapes and are arranged alternately in the direction intersecting with the arranging direction of the LEDs 17. In this configuration, light from the respective LEDs 17 constituting the respective LED groups 20 is reflected by the low light reflectance areas LRA and the high light reflectance areas HRA formed in strip shapes and arranged alternately in the direction intersecting with the arranging direction of the LEDs 17, and thus a difference in contrast does not occur easily between the light source arranging areas LA and the light source non-arranging areas LN. In comparison with a configuration in which only one LED group 20 is provided, the present configuration suppresses occurrence of uneven brightness and is suitable for an increase in size of the backlight unit 12.

The plurality of low light reflectance areas LRA is arranged and has approximately equal width dimensions to one another. In this configuration, the amounts of light reflected by the respective low light reflectance areas LRA can be approximately equal, which is further suitable for suppression of uneven brightness.

The plurality of high light reflectance areas HRA is arranged and has approximately equal width dimensions to one another. In this configuration, the amounts of light reflected by the respective high light reflectance areas HRA can be approximately equal, which is further suitable for suppression of uneven brightness.

The interval between the LEDs 17 that are adjacent to each other in the arranging direction of the LEDs 17 is shorter than the interval between the LED groups 20 that are adjacent to each other. In this configuration, even in a configuration where the LEDs 17 are densely arranged in the light source arranging areas LA, an excessive increase in light amount can be suppressed suitably by the low light reflectance areas LRA.

The LEDs 17 constituting each LED group 20 are arranged approximately at regular intervals. This configuration is more suitable for suppression of uneven brightness than a configuration where the LEDs 17 are unevenly distributed.

The chassis 14 is in an elongated shape, and the arranging direction of the LEDs 17 constituting the LED group 20 is aligned with the shorter side direction of the chassis 14. In this configuration, the length dimension of the light source arranging area LA is shorter than that in a configuration where the arranging direction of the LEDs 17 is aligned with the longer side direction of the chassis 14. Thus, the difference in contrast from the light source non-arranging area LN that can occur is not recognized easily, which is suitable for prevention of uneven brightness.

The lighting device according to the present invention further includes the LED boards 18 arranged in the chassis 14 and having the LEDs 17 constituting the LED groups 20. In this configuration, the plurality of LEDs 17 constituting the LED groups 20 can be arranged in the chassis 14 collectively by arranging the LED boards 18 in the chassis 14, which provides excellent assembling workability.

Each LED board 18 is in an elongated shape, and the arranging direction of the LEDs 17 constituting the LED group 20 is aligned with the longer side direction of the LED board 18. In this configuration, the LEDs 17 can be arranged on the elongated LED board 18 efficiently.

The low light reflectance area LRA has a surface color different from the high light reflectance area HRA. In this configuration, the light reflectance in each area can be adjusted easily by setting each surface color arbitrarily.

The high light reflectance area HRA is white. In this configuration, high light reflectance can be obtained, and thus the light amount in the light source non-arranging area LN can be compensated sufficiently.

The low light reflectance area LRA is black. In this configuration, low light reflectance can be obtained, and thus an excessive increase in light amount in the light source arranging area LA can further suitably be suppressed.

The reflection sheet 19 has the high light reflectance portions 21 constituting the high light reflectance areas HRA and the low light reflectance portions 22 constituting the low light reflectance areas LRA. In this configuration, since the high light reflectance portions 21 and the low light reflectance portions 22 are a part of the reflection sheet 19, the number of components can be reduced further than in a configuration where the high light reflectance portions 21 or the low light reflectance portions 22 are separate components from the reflection sheet 19, which is suitable for cost reduction.

Either the low light reflectance portions 22 or the high light reflectance portions 21 is made by coloring the surface of the reflection sheet 19. In this configuration, the low light reflectance portions 22 and the high light reflectance portions 21 can be formed on the reflection sheet 19 integrally at lower cost than in a configuration where both the low light reflectance portions 22 and the high light reflectance portions 21 are formed by coloring the surface of the reflection sheet 19.

The low light reflectance portions 22 are made by coloring the surface of the reflection sheet 19. In a configuration where the high light reflectance portions are formed by coloring, a material for use in coloring needs to have higher light reflectance than that of the surface of the reflection sheet 19, and thus there are few options for the material, and the material tends to be costly. In this respect, in the present embodiment, since the low light reflectance portions 22 are formed by coloring, there are many options for the material for use in coloring, and the material can be provided at low cost.

The light reflectance of the surface in the chassis 14 opposed to the optical member 15 is in two levels. In this configuration, the light reflectance of the surface in the chassis 14 opposed to the optical member 15 is set easily, which is excellent in manufacture of the backlight unit 12.

The light sources are the LEDs 17. In this configuration, high brightness and low power consumption can be achieved.

Although the first embodiment of the present invention has been provided above, the present invention is not limited to the above embodiment but can include the following modification examples, for example. In some of the following modification examples, similar components to those in the above embodiment are shown with the same reference numerals as those in the above embodiment, and illustration and description of the duplicate components are omitted.

### First Modification of First Embodiment

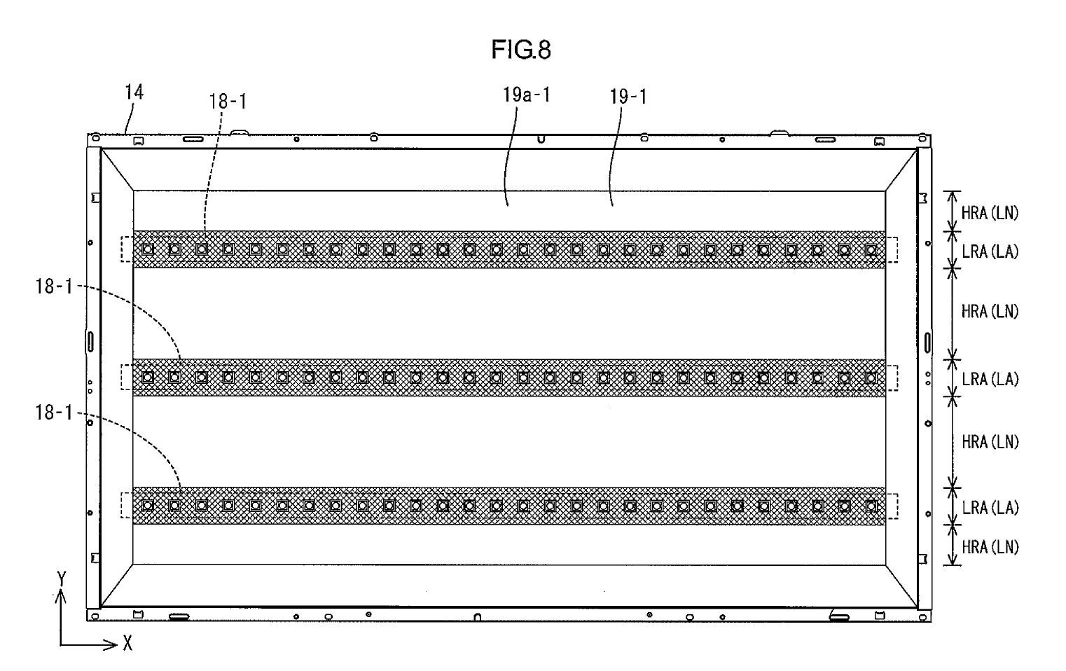

A first modification of the first embodiment will be described with reference to FIG. 8. In this example, arrangement of LED boards 18-1 is changed.

Each LED board 18-1 according to the present modification is formed in a horizontally long shape and is arranged in the chassis 14 in a posture in which a length direction thereof is aligned with the X axial direction or the longer side direction of the chassis 14 (reflection sheet 19-1) and in which a width direction thereof is aligned with the Y axial direction or the shorter side direction of the chassis 14 as illustrated in FIG. 8. The LED board 18-1 lies across the entire area of the bottom plate 14a (bottom portion 19a-1) of the chassis 14 along the longer side direction of the bottom plate 14a. Three LED boards 18-1 are arranged intermittently in the Y axial direction. Accordingly, on the bottom portion 19a-1 of the reflection sheet 19-1, each of the light source arranging areas LA, that is the low light reflectance areas LRA is in a horizontally long strip shape along the length direction of each LED board 18-1, and three light source arranging areas LA and three low light reflectance areas LRA are arranged at specified intervals in the Y axial direction. On the other hand, on the bottom portion 19a-1 of the reflection sheet 19-1, each of the light source non-arranging areas LN, that is the high light reflectance areas HRA is in a horizontally long strip shape along the length direction of each LED board 18-1, and the light source non-arranging areas LN, that is the highlight reflectance areas HRA consist of ones that lie between the light source arranging areas LA (low light reflectance areas LRA) adjacent to each other in the Y axial direction and ones that are located closer to the end sides than the light source arranging areas LA (low light reflectance areas LRA) on both sides.

### Second Modification of First Embodiment

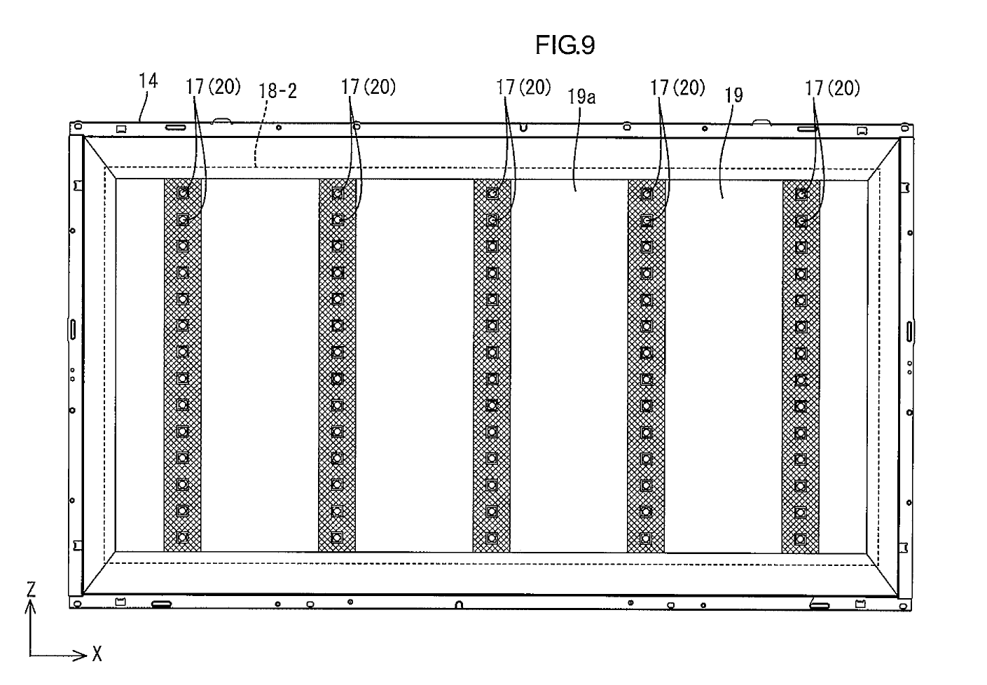

A second modification of the first embodiment will be described with reference to FIG. 9. In this example, a shape and size of an LED board 18-2 are changed.

The LED board 18-2 according to the present modification is formed in a horizontally long shape and is one size larger than the bottom plate 14a (bottom portion 19a) of the chassis 14 (reflection sheet 19) as illustrated in FIG. 9. That is, the LED board 18-2 is large so as to be arranged approximately over the entire area of the bottom plate 14a (bottom portion 19a). On the LED board 18-2, the plurality of LEDs 17 constituting the respective LED groups 20 is arranged along the Y axial direction.

### Second Embodiment

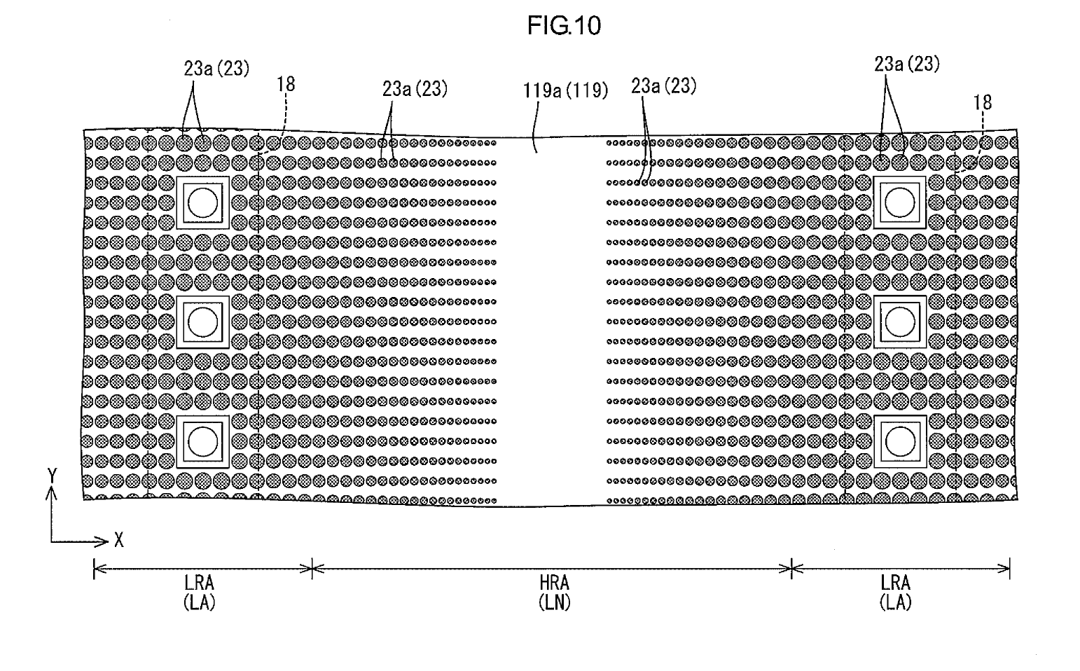

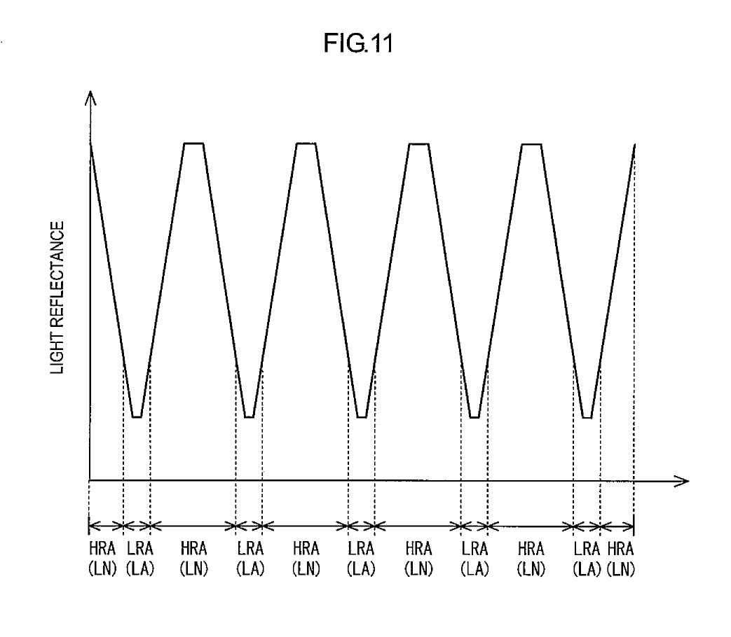

A second embodiment of the present invention will be described with reference to FIG. 10 or 11. In the second embodiment, a distribution of light reflectance on a reflection sheet 119 is changed. Duplicate description of similar structures and effects to those of the above first embodiment is omitted.

On a bottom portion 119a of the reflection sheet 119 according to the present embodiment is provided with a dot pattern 23 made of a material having lower light reflectance than that of a surface thereof as illustrated in FIG. 10. The dot pattern 23 is black and is formed by being printed on the surface of the bottom portion 119a by a printing means such as inkjet printing. The dot pattern 23 is constituted by arranging multiple dots 23a, each formed in a round shape in a planar view, in a matrix form along the X axial direction and the Y axial direction. The dots 23a have equal areas at parts overlapping with the LED boards 18 in a planar view and reduce areas continuously and gradually (change areas in slope shapes) toward directions away from the LED boards 18 in the X axial direction at parts not overlapping with the LED boards 18. At a center part of each light source non-arranging area LN in the X axial direction, no dots 23a are formed. Accordingly, the light reflectance on the bottom portion 119a of the reflection sheet 119 is decreased continuously and gradually in the X axial direction from each light source arranging area LA to each light source non-arranging area LN as illustrated in FIG. 11. Each of the light source arranging areas LA and the light source non-arranging areas LN has an area having constant light reflectance. By forming such a dot pattern 23 on the bottom portion 119a of the reflection sheet 119, each light source arranging area LA is the low light reflectance area LRA, which has relatively low light reflectance, while each light source non-arranging area LN is the high light reflectance area HRA, which has relatively high light reflectance.

As described above, according to the present embodiment, the light reflectance on the surface in the chassis 14 facing the optical member 15 is decreased continuously and gradually from each light source arranging area LA to each light source non-arranging area LN. In this manner, by setting the light reflectance on the surface in the chassis 14 opposed to the optical member 15 so as to form gradation from each light source arranging area LA to each light source non-arranging area LN, and more specifically, by decreasing it continuously and gradually, a brightness distribution of outgoing light can be smooth, which is further suitable for suppression of uneven brightness.

On the surface of the reflection sheet 119 is formed the dot pattern 23 made of a material having lower light reflectance than that of the surface thereof. In this configuration, the degree of reflection can be controlled appropriately in accordance with the conditions (number, area, and the like) of the dot pattern 23, and thus a brightness distribution of outgoing light can be smoother.

### Third Embodiment

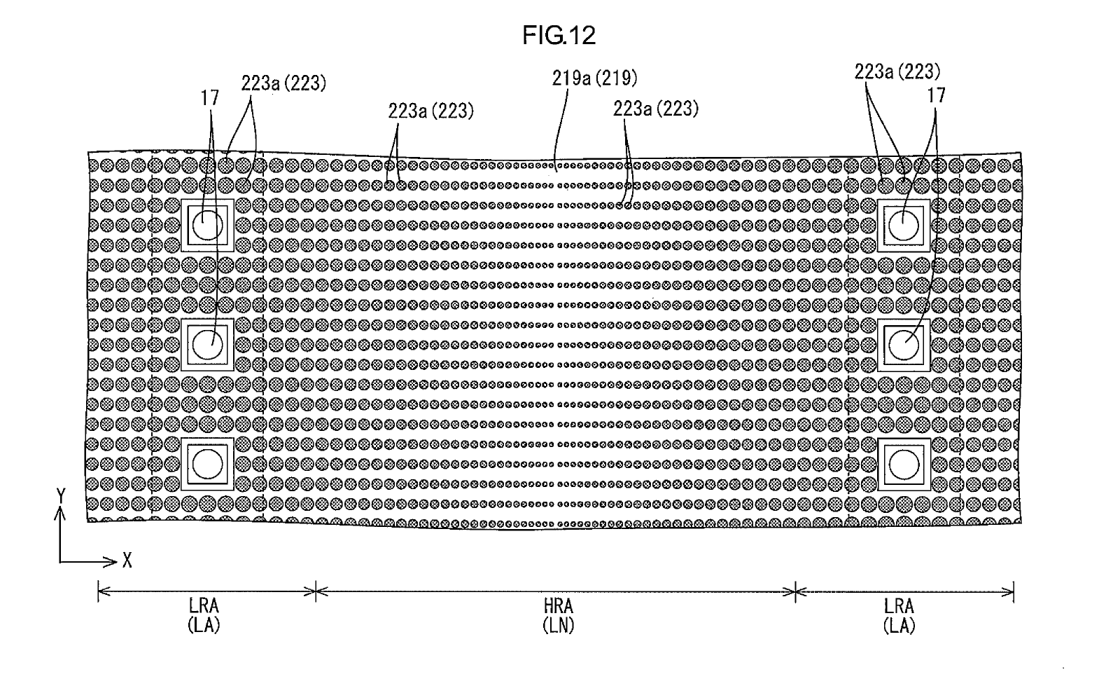

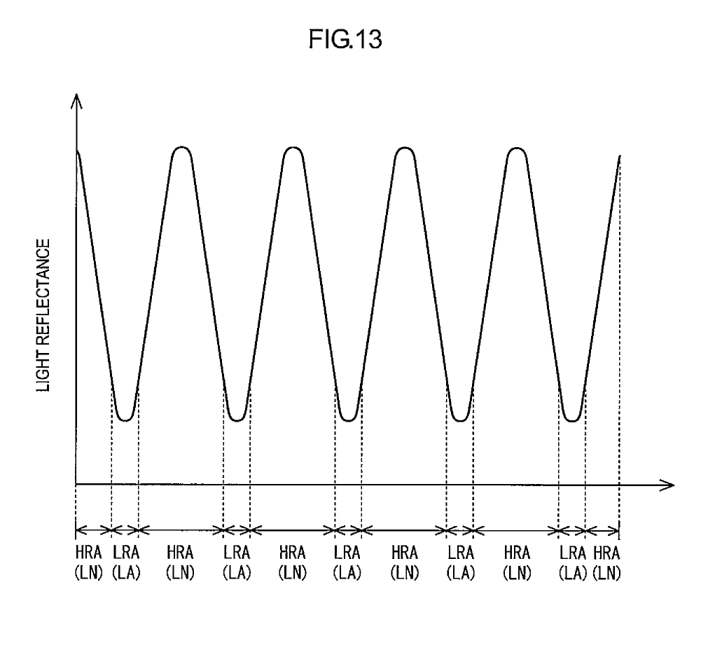

A third embodiment of the present invention will be described with reference to FIG. 12 or 13. In the third embodiment, a distribution of light reflectance on a reflection sheet 219 is changed further from that in the above second embodiment. Duplicate description of similar structures and effects to those of the above second embodiment is omitted.

Dots 223a constituting a dot pattern 223 formed on a bottom portion 219a of the reflection sheet 219 according to the present embodiment have largest areas at equal positions to those of the LEDs 17 in the X axial direction and reduce areas gradually toward directions away from the LEDs 17 in the X axial direction as illustrated in FIG. 12. That is, the area of each dot 223a is set to be smaller as the distance in the X axial direction from the LEDs 17 is larger. The dots 223a are formed approximately over the entire area on the surface of the bottom portion 219a. Accordingly, the light reflectance on the bottom portion 219a of the reflection sheet 219 is decreased continuously and gradually in the X axial direction from each light source arranging area LA to each light source non-arranging area LN as illustrated in FIG. 13. Each of the light source arranging areas LA and the light source non-arranging areas LN does not have an area having constant light reflectance. By forming such a dot pattern 223 on the bottom portion 219a of the reflection sheet 219, each light source arranging area LA is the low light reflectance area LRA, which has relatively low light reflectance, while each light source non-arranging area LN is the high light reflectance area HRA, which has relatively high light reflectance.

### Fourth Embodiment

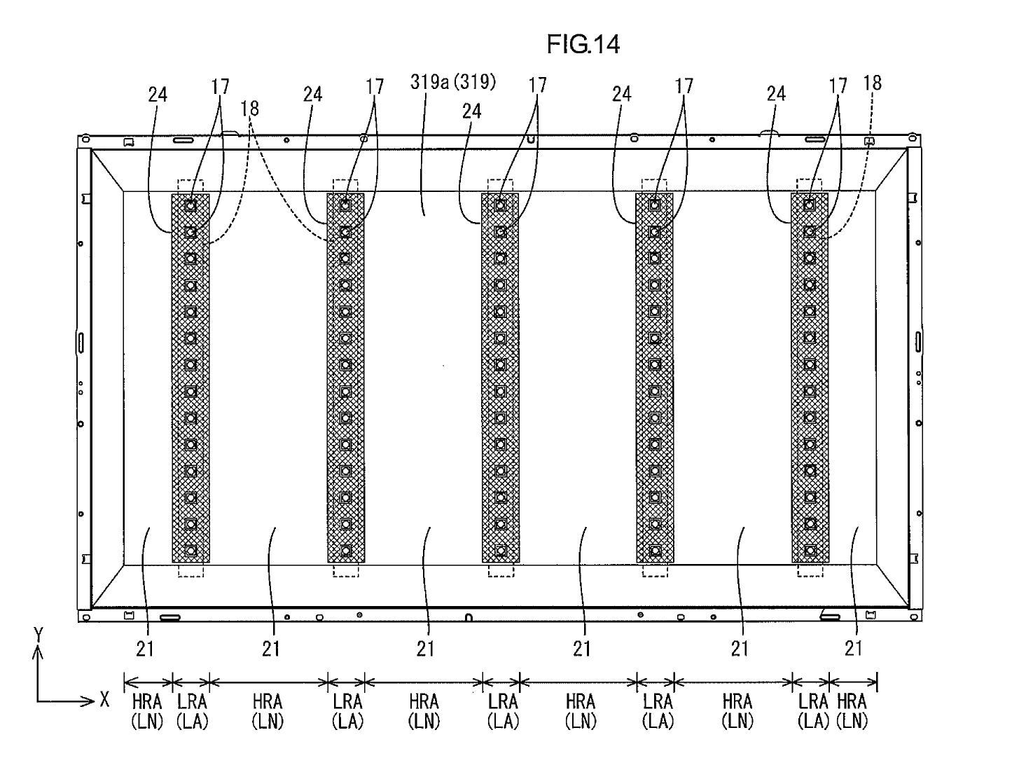

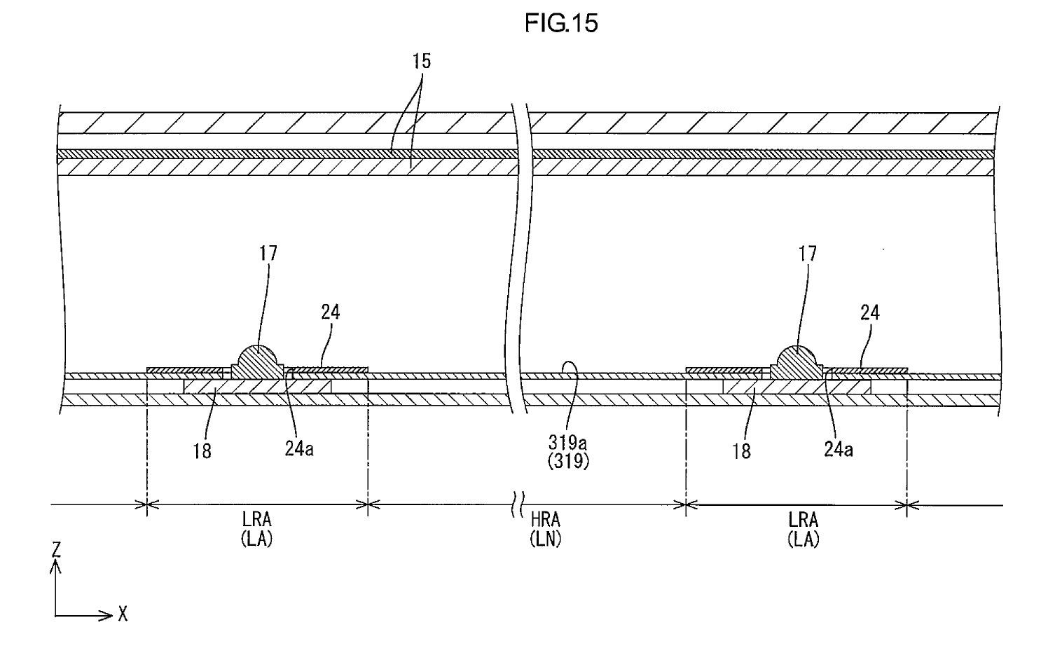

A fourth embodiment of the present invention will be described with reference to FIG. 14 or 15. In the fourth embodiment, low light reflectance members 24 are provided separately from a reflection sheet 319. Duplicate description of similar structures and effects to those of the above first embodiment is omitted.

On the respective light source arranging areas LA on a bottom portion 319a of the reflection sheet 319 according to the present embodiment, the low light reflectance members 24, which are separate components from the reflection sheet 319, are respectively arranged to overlap with the front side of the reflection sheet 31 as shown in FIGS. 14 and 15. Each low light reflectance member 24 is in a vertically long strip shape to conform to each light source arranging area LA (LED board 18) and has light reflectance on the surface lower than that of the reflection sheet 319. The surface of the low light reflectance member 24 is black. In the present embodiment, each low light reflectance member 24 constitutes the low light reflectance area LRA, and each area of the bottom portion 319a not covered with the low light reflectance member 24, that is, each area not overlapping with the low light reflectance member 24 in a planar view, is the high light reflectance area HRA. In the low light reflectance member 24 are opened and formed light source inserting holes 24a having the respective LEDs 17 inserted therein individually.

As described above, according to the present embodiment, the reflection sheet 319 has the high light reflectance portions 21 constituting the high light reflectance areas HRA and is provided with the low light reflectance members 24 constituting the low light reflectance areas LRA to overlap with the reflection sheet 319. In this configuration, by adding the low light reflectance members 24, an existing sheet (one in a state where no black paint is applied such as that in the first embodiment) can be used as it is as the reflection sheet 319. Accordingly, cost for the reflection sheet 319 can be reduced to be low.

The low light reflectance members 24 are arranged to overlap with the reflection sheet 319 on a side of the optical member 15. In this configuration, although openings that expose the low light reflectance members need to be formed in the reflection sheet 319 in a configuration where the low light reflectance members are arranged on the reflection sheet 319 on an opposite side of the side of the optical member 15, this is not needed in the present embodiment, and thus cost for the reflection sheet 319 can be reduced to be low.

### Fifth Embodiment

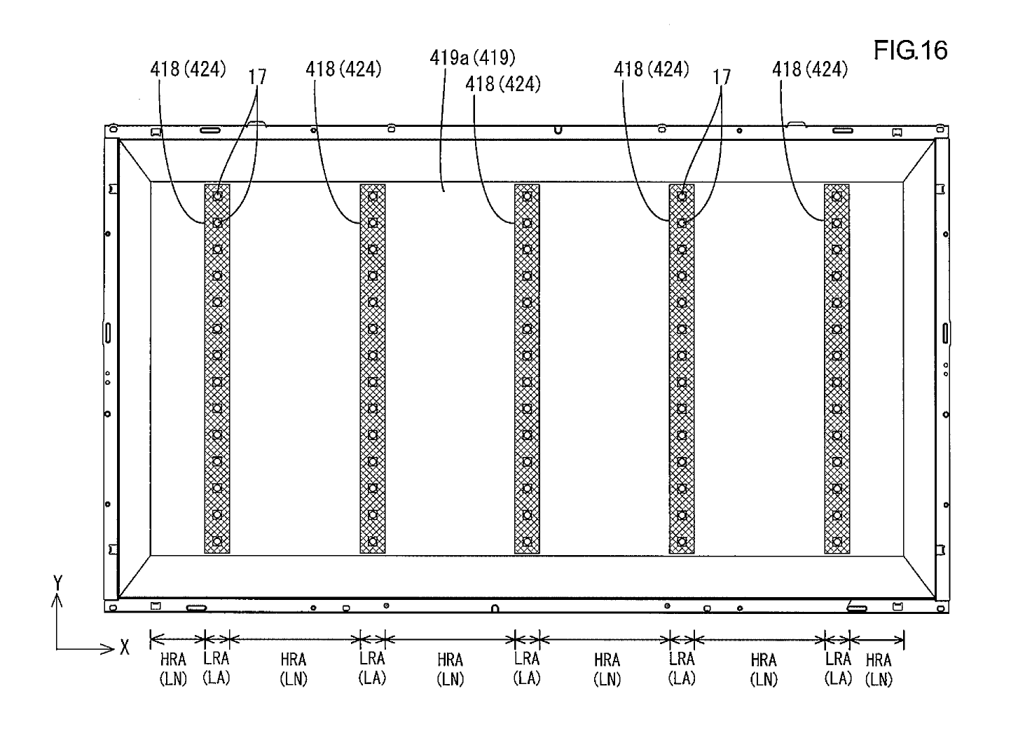

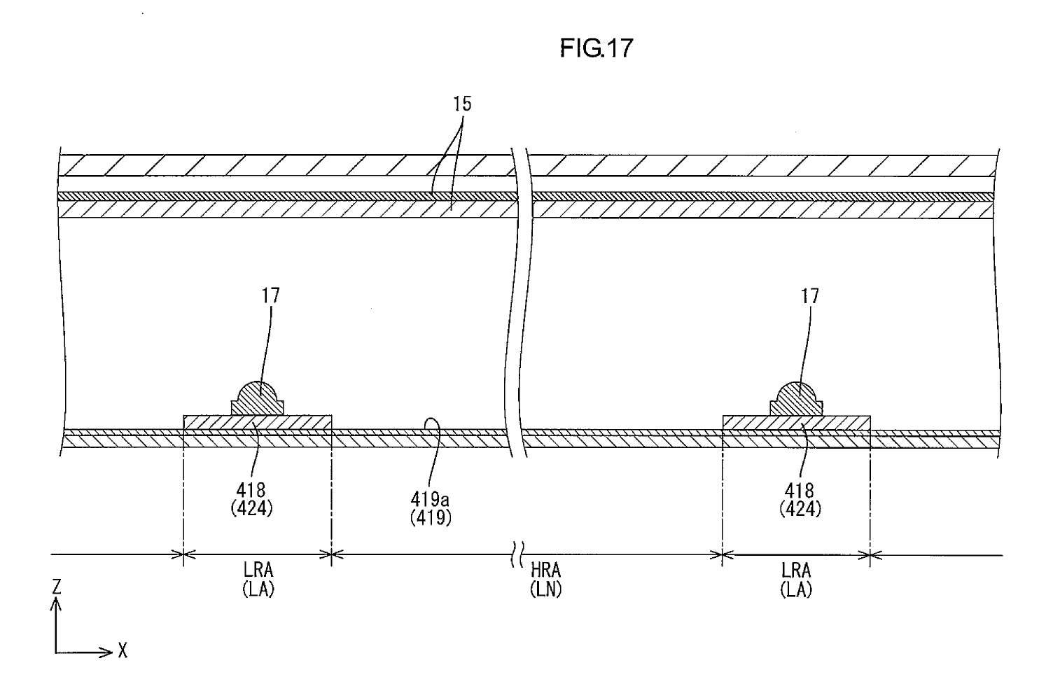

A fifth embodiment of the present invention will be described with reference to FIG. 16 or 17. In the fifth embodiment, low light reflectance members 424 shown in the above fourth embodiment are made to be LED boards 418. Duplicate description of similar structures and effects to those of the above fourth embodiment is omitted.

Each LED board 418 has light reflectance on a surface thereof lower than that of a reflection sheet 419 and constitutes the low light reflectance member 424 as illustrated in FIGS. 16 and 17. The LED board 418 is black on the surface. The LED board 418 is arranged to overlap with the reflection sheet 419 on the front side closer than the reflection sheet 419, and the entire area of the front side surface thereof is exposed to a side of the optical member 15. In the present embodiment, the LED boards 418 as the low light reflectance members 424 constitute the low light reflectance areas LRA, and areas of a bottom portion 419a that are not covered with the LED boards 418, that is, areas that do not overlap with the LED boards 418 in a planar view, are the high light reflectance areas HRA. Thus, each low light reflectance areas LRA according to the present embodiment is equal to each LED board 418 in terms of the width dimension. Meanwhile, since the reflection sheet 419 is arranged on the back sides of the LED boards 418, the reflection sheet 419 does not have light source inserting holes shown in the above first to fourth embodiments.

As described above, according to the present embodiment, the lighting device further includes the LED boards 418 having the LEDs 17, and the low light reflectance members 424 includes the LED boards 418. In this configuration, since the LED boards 418 having the LEDs 17 are the low light reflectance members 424, the number of components can be reduced further than in the fourth embodiment, in which the low light reflectance members are separate components from the LED boards 418 and the reflection sheet 419, which is suitable for cost reduction.

### Other Embodiment

The present invention is not limited to the above embodiments explained in the above description. The following embodiments may be included in the technical scope of the present invention, for example.

(1) A configuration where the width dimension of each light source arranging area is longer than the width dimension of each LED board has been illustrated in the above first to fourth embodiments, and a configuration where the width dimension of each light source arranging area is equal to the width dimension of each LED board has been illustrated in the fifth embodiment. However, a configuration where the width dimension of each light source arranging area is shorter than the width dimension of each LED board is also included in the present invention.

(2) A configuration where the width dimension of each light source arranging area is ½ or less of the width dimension of each light source non-arranging area has been illustrated in the above first embodiment. However, a configuration where the width dimension of each light source arranging area is ½ or more of the width dimension of each light source non-arranging area is also included in the present invention.

(3) A configuration where the width dimension of each light source arranging area is shorter than the width dimension of each light source non-arranging area has been illustrated in each of the above embodiments. However, a configuration where the width dimension of each light source arranging area is longer than or equal to the width dimension of each light source non-arranging area is also included in the present invention.

(4) A configuration where the length dimension of each light source arranging area is approximately equal to the shorter side dimension of the bottom portion of the reflection sheet has been illustrated in each of the above embodiments. However, a configuration where the length dimension of each light source arranging area is shorter or longer than the shorter side dimension of the bottom portion of the reflection sheet is also included in the present invention. Further, in the configuration where the length dimension of each light source arranging area is longer than the shorter side dimension of the bottom portion of the reflection sheet, the low light reflectance area has only to be provided to extend to the rising portion of the reflection sheet.

(5) A configuration where the low light reflectance member constituting the low light reflectance area is used as a separate component from the reflection sheet has been described in the above fourth embodiment. However, a configuration where a high light reflectance member constituting the high light reflectance area is used as a separate component from the reflection sheet is also included in the present invention. In this case, a preferred example of the high light reflectance member is one having a dielectric multilayer film structure that produces extremely high light reflectance, and specifically, a product name “ESR” manufactured by Sumitomo 3M Ltd. or the like can be used.

(6) A configuration where the low light reflectance area is black has been illustrated in each of the above embodiments. However, the black color can be changed to a color having relatively lower luminosity than that of the color of the high light reflectance area (white), such as gray.

(7) A configuration where the high light reflectance area is white has been illustrated in each of the above embodiments. However, the white color can be changed to a color having relatively higher luminosity than that of the color of the high light reflectance area (black), such as milky white and silver.

(8) A configuration where the high light reflectance area and the low light reflectance area have colors different from each other has been described in each of the above embodiments. However, while the high light reflectance area and the low light reflectance area have an equal color (white), the high light reflectance area and the low light reflectance area may have different light reflectance by carrying out a surface treatment (specifically, a roughening process or the like) on the reflection sheet, for example.

(9) A configuration where the low light reflectance portion (low light reflectance area) is formed by applying paint on the surface of the reflection sheet has been described in the above first to third embodiments. However, the low light reflectance portion may be formed by printing ink on the surface of the reflection sheet by an inkjet device, for example.

(10) A configuration where the low light reflectance portion (low light reflectance area) is formed by coloring the surface of the reflection sheet has been described in the above first to third embodiments. However, the high light reflectance portion (high light reflectance area) can be formed by coloring.

(11) A configuration where only the low light reflectance portion (low light reflectance area) is formed by coloring the surface of the reflection sheet has been described in the above first to third embodiments. However, both the low light reflectance portion and the high light reflectance portion can be formed by coloring.

(12) A configuration where the width dimensions of the plurality of low light reflectance areas are equal has been described in each of the above embodiments. However, the width dimensions of the plurality of low light reflectance areas may be different from each other.

(13) A configuration where the width dimensions of the plurality of high light reflectance areas lying between the low light reflectance areas adjacent to each other are equal has been described in each of the above embodiments. However, the width dimensions of the plurality of high light reflectance areas may be different from each other.

(14) A configuration where the LEDs constituting the LED group are arranged at regular intervals has been illustrated in each of the above embodiments. However, a configuration where the LEDs constituting the LED group are arranged at irregular intervals is also included in the present invention.

(15) A configuration where the LEDs constituting the LED group are arranged linearly has been illustrated in each of the above embodiments. However, a configuration where the LEDs constituting the LED group are arranged in a curved line is also included in the present invention. In this case, a boundary surface between the low light reflection area and the high light reflection area is in a curved line.

(16) The number of LED groups (the number of low light reflectance areas) arranged in the chassis and the number of LEDs constituting each LED group can be changed arbitrarily, instead of those in each of the above embodiments.

(17) A configuration where the LEDs are used as light sources has been described in each of the above embodiments. However, linear light sources such as a cold cathode tube and a hot cathode tube can also be used instead of the LEDs.

(18) A configuration where each of the liquid crystal panel and the chassis is in a vertically-placed state in which the shorter side direction is aligned with the vertical direction has been illustrated in each of the above embodiments. However, a configuration where each of the liquid crystal panel and the chassis is in a vertically-placed state in which the longer side direction is aligned with the vertical direction is also included in the present invention.

(19) The TFTs are used as switching components of the liquid crystal display device in each of the above embodiments. However, the present invention can also be applied to a liquid crystal display device using switching components other than the TFTs (e.g., Thin-Film Diodes (TFDs)) and can also be applied to a liquid crystal display device for monochrome display, not only to a liquid crystal display device for color display.

(20) The liquid crystal display device using the liquid crystal panel as a display panel has been illustrated in each of the above embodiments. However, the present invention can be also applied to a display device using another kind of display panel.

(21) The television device including the tuner has been illustrated in each of the above embodiments. However, the present invention can also be applied to a display device not including the tuner.

### EXPLANATION OF SYMBOLS

10: Liquid crystal display device (Display device)
11: Liquid crystal panel (Display panel)
12: Backlight unit (Lighting device)
14: Chassis
14b: Opening
15: Optical member
17: LED (Light source) 18, 418: LED board (Light source board) 19, 119, 219, 319, 419: Reflection sheet (Reflection member)
20: LED group (Light source group)
21: High light reflectance portion
22: Low light reflectance portion
23, 223: Dot pattern
24, 424: Low light reflectance member
HRA: High light reflectance area
LA: Light source arranging area
LN: Light source non-arranging area
LRA: Low light reflectance area
TV: Television device

1. A lighting device comprising:
a light source;
a chassis housing the light source and including an opening through which light from the light source exits;
an optical member provided to cover the opening and face the light source; and
a reflection member arranged in the chassis to face the optical member, the reflection member including a surface facing the optical member, and the surface including a light source arrangement area in which the light source is arranged and a light source non-arrangement area in which no light source is arranged, wherein the light source arrangement area is a low light reflectance area having relatively low light reflectance and the light source non-arrangement area is a high light reflectance area having relatively high light reflectance.

2. The lighting device according to claim 1, wherein
the light source includes a plurality of light sources that are arranged linearly to form a light source group, and
the light source arrangement area that corresponds to the low light reflectance area is formed in a strip shape extending along an arranging direction in which the light sources included in the light source group are arranged.

3. The lighting device according to claim 2, wherein
the light source group includes a plurality of light source groups that are arranged at intervals in a direction intersecting with the arranging direction of the light sources,
the light source arrangement area that corresponds to the low light reflectance area includes a plurality of light source arrangement areas and the light source non-arrangement area that corresponds to the high light reflectance area includes a plurality of light source non-arrangement areas, and each of the light source arrangement areas, the low light reflectance areas, the light source non-arrangement areas and the high light reflectance areas is formed in a strip shape, and
the light source arrangement areas and the light source non-arrangement areas are arranged alternately in the direction intersecting with the arranging direction of the light sources.

4. The lighting device according to claim 3, wherein each of the low light reflectance areas has an approximately equal width dimension.

5. The lighting device according to claim 3, wherein each of the high light reflectance areas has an approximately equal width dimension.

6. The lighting device according to claim 3, wherein the light sources adjacent to each other in the arranging direction of the light sources have an interval therebetween smaller than an interval between the light source groups that are adjacent to each other.

7. The lighting device according to claim 2, wherein the light sources included in the light source group are arranged approximately at regular intervals.

8. The lighting device according to claim 2, wherein
the chassis is formed in an elongated shape having a short side and a long side, and
the arranging direction of the light sources included in the light source group is aligned with the short side of the chassis.

9. The lighting device according to claim 2, further comprising:
a light source board arranged in the chassis and having the light sources included in the light source groups thereon.

10. The lighting device according to claim 9, wherein
the light source board is formed in an elongated shape having a short side and a long side, and
the arranging direction of the light sources included in the light source group is aligned with the long side of the light source board.

11. The lighting device according to claim 1, wherein the low light reflectance area has a surface color different from the high light reflectance area.

12. The lighting device according to claim 11, wherein the high light reflectance area is white.

13. The lighting device according to claim 11, wherein the low light reflectance area is black.

14. The lighting device according to claim 1, wherein the reflection member includes a high light reflectance portion configuring the high light reflectance area and a low light reflectance portion configuring the low light reflectance area.

15. The lighting device according to claim 14, wherein one of the low light reflectance portion and the high light reflectance portion includes the reflection member having a colored surface.

16. The lighting device according to claim 15, wherein the low light reflectance portion includes the reflection member with a colored surface.

17. The lighting device according to claim 1, wherein the reflection member includes a high light reflectance portion configuring the high light reflectance area, and a low light reflectance portion configuring the low light reflectance area is arranged to overlap with the reflection member.

18. The lighting device according to claim 17, wherein the low light reflectance portion is arranged to overlap with the reflection member on a side of the optical member.

19-23. (canceled)

24. A display device comprising:
the lighting device according to claim 1; and
a display panel displaying with use of light from the lighting device.

25. (canceled)

26. A television device comprising:
the display device according to claim 24.
